(19) United States
(12) Patent Application Publication
(10) Pub. No.: US 2019/0130473 A1
(43) Pub. Date: May 2, 2019

(54) SYSTEMS AND METHODS FOR DISTRIBUTED COMMERCE, SHOPPABLE ADVERTISEMENTS AND LOYALTY REWARDS

(71) Applicant: Constant Commerce Ltd., London (GB)

(72) Inventor: Johnathan Agnes, Cobham (GB)

(21) Appl. No.: 16/232,597

(22) Filed: Dec. 26, 2018

Related U.S. Application Data
(63) Continuation of application No. 14/490,587, filed on Sep. 18, 2014.
(60) Provisional application No. 61/879,639, filed on Sep. 18, 2013.
(60) Provisional application No. 61/903,854, filed on Nov. 13, 2013.

(51) Int. Cl. G06Q 30/06; G06Q 30/02

(52) U.S. Cl. CPC G06Q 30/0635; G06Q 30/0601; G06Q 30/0277

(57) ABSTRACT

A distributed commerce system includes a distributed commerce server that enables a shopper (or user) to directly add one or more products, services, coupons or special offers to an electronic shopping basket, or to a cloud shopping list, over a data network from within one or more merchant systems (without the need to leave a specific web-page or functionality within the merchant system). The shopper can also purchase in-store, create and manage e-commerce and in-store commerce accounts, and earn rewards when one or more purchases have been made.

### CROSS-REFERENCE TO RELATED APPLICATIONS

The present application is a continuation of and claims priority to U.S. patent application Ser. No. 14/490,587, filed on Sep. 18, 2014, which application claimed priority to U.S. Provisional Patent Application Ser. No. 61/879,639, filed on Sep. 18, 2013, entitled “Shoppable Advertisements and Cloud Lists for E-Commerce” and U.S. Provisional Patent Application Ser. No. 61/903,854, filed on Nov. 13, 2013, entitled “Shoppable Video for E-Commerce.” U.S. patent application Serial No. 14/490,587 and U.S. Provisional Patent Application Ser. Nos. 61/879,639 and 61/903,854 are herein incorporated by reference in their entireties and for all purposes.

### FIELD OF THE INVENTION

Embodiments are directed to systems and methods for electronic commerce (“e-commerce”), and more specifically, to systems and methods for distributed commerce systems that, for example, integrate shoppable advertisements and provide interactive commerce management.

### BACKGROUND

Electronic commerce, commonly known as e-commerce, is a type of industry where the buying and selling of products or services is conducted using electronic systems over data networks such as the Internet and other computer networks. Electronic commerce draws on technologies such as mobile commerce, electronic funds transfer, supply chain management, Internet marketing, online transaction processing, electronic data interchange (EDI), inventory management systems, and automated data collection systems. Modern electronic commerce typically uses the World Wide Web at least once in a transaction's life cycle, although it may encompass a wider range of technologies such as e-mail, mobile devices, social media, and telephones as well. E-commerce also includes the exchange of data to facilitate the financing and payment aspects of business transactions.

Online advertising, also called Internet advertising, uses the Internet to deliver promotional marketing messages to consumers. It includes e-mail marketing, search engine marketing, social media marketing, many types of display advertising (including web banner advertising), and mobile advertising. Like other advertising media, online advertising frequently involves both a publisher, who integrates advertisements into its online content, and an advertiser, who provides the advertisements to be displayed on the publisher's content. Other potential participants include advertising agencies that help generate and place the advertisement copy, an advertisement server that technologically delivers the advertisement and tracks statistics, and advertising affiliates who do independent promotional work for the advertiser. Online advertising is a large business that is growing rapidly. In 2011, Internet advertising revenues in the United States surpassed those of cable television and nearly exceeded those of broadcast television. In 2012, Internet advertising revenues in the United States totaled $36.57 billion—a 15.2% increase over the $31.74 billion in revenues in 2011. Online advertising is widely used across virtually all industry sectors.

Unfortunately, electronic advertising's main purpose of selling a product or service is often disconnected from e-commerce to buy that product or service. When a user sees an electronic advertisement (also called an “impression”), the user may or may not click on (or otherwise interact with) the advertisement. Even if the user does interact with the advertisement, doing so typically only takes the user to some static information (e.g., a landing page on a website) to further describe the product or service being advertised. If the user actually wants to purchase the product or service, the purchasing process often takes the user many steps, which may include leaving the original website or application the user was using, finding the product, placing the product in an online shopping cart, and going through an electronic checkout process to pay for and arrange delivery of the product or service. This process is so onerous that advertisers must work to optimize the conversion rate, or the number of viewers of the advertisement that the advertisers can convert into customers.

Accordingly, a need exists for an improved system and method for integrating electronic advertisements, cloud lists, and shoppable videos, with electronic commerce systems in an effort to overcome the aforementioned obstacles and deficiencies of prior art systems.

### BRIEF DESCRIPTION OF THE DRAWINGS

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a schematic diagram of a distributed commerce system including databases, content and data management tools, services and processes and a plurality of merchant systems in communication over a data network, in accordance with one embodiment.

FIG. 2 is a diagram illustrating one embodiment of the services and processes of FIG. 1.

FIG. 3 is a schematic diagram illustrating one embodiment of the data management tools of FIG. 1.

FIG. 4 is a diagram showing an integration of the distributed commerce system of FIG. 1 with one or more merchant systems, according to one embodiment.

FIG. 5 is a diagram illustrating one embodiment of the distributed commerce tools of FIG. 1.

FIG. 6 is a schematic diagram showing one embodiment of an “add-to-basket” and an “add-to-cloud-list” feature using the services and processes of FIG. 1 and FIG. 2.

FIG. 7 is a schematic diagram showing one embodiment of an “add-to-basket” proof of purchase feature using the services and processes of FIG. 1 and FIG. 2.

FIG. 8 is a schematic diagram showing one embodiment of an “add-to-cloud-list” proof of purchase feature using the services and processes of FIG. 1 and FIG. 2.

FIGS. 9-19 are display diagrams that illustrate an e-commerce integration provided by the system of FIG. 1, in one embodiment.

FIGS. 20-26 are display diagrams that illustrate the cloud list provided by the system, in one embodiment.

FIG. 27 is a display diagram that illustrates a shoppable video provided by the system, in one embodiment.

### DETAILED DESCRIPTION OF PREFERRED EMBODIMENTS

Distributed Commerce System Overview

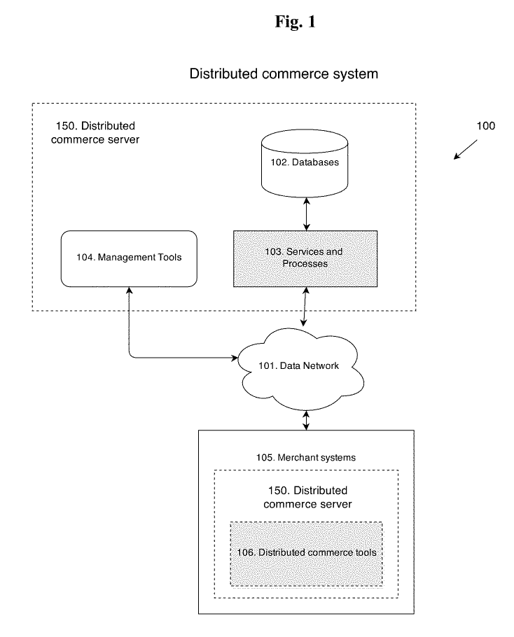

On FIG. 1, a distributed commerce system 100 includes a distributed commerce server 150 that enables a shopper (or user) to directly add one or more products, services, coupons or special offers to an electronic shopping basket, or to a cloud shopping list, over a data network 101 from within one or more merchant systems 105 (without the need to leave a specific web-page or functionality within the merchant systems 105). The shopper can also purchase in-store, create and manage e-commerce and in-store commerce accounts, and earn rewards when one or more purchases have been made. As illustrated, the distributed commerce server 150 includes databases 102, services and processes 103, management tools 104, and distributed commerce tools 106. The distributed commerce tools 106 can be accessed by a user directly on the distributed commerce server 150 of via a merchant system 105 where the tools 106 can be embedded.

The distributed commerce system 100 powers the distributed commerce tools 106, which are available to the shopper (or user) via the one or more merchant systems 105. In one embodiment, the distributed commerce tools 106 include embeddable widgets, application programming interfaces (APIs), software development kits (SDKs), and digital advertising, each allowing the consumer to add one or more products to a retailer e-commerce account, or to a network-based (e.g., via cloud computing) shopping list (also referred to as a “cloud list”).

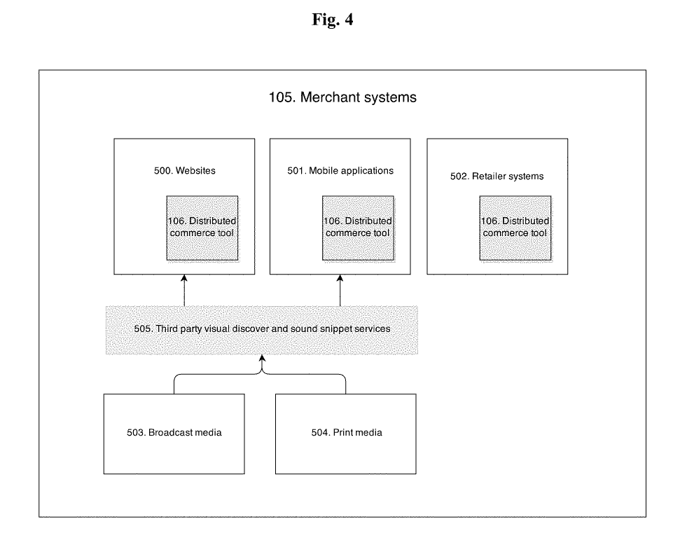

The distributed commerce tools 106 can all have a high level of context awareness, so that a “call-to-action” and even content, product suggestions, special offers, coupons, and services can be targeted to a selected user. In one embodiment, the merchant systems 105 (further illustrated in FIG. 4) include servers for hosting websites, mobile applications, and other media belonging to, but not exclusively to, retailers, publishers and CPG manufacturers. The distributed commerce tools 106 communicate with services and processes 103, which are hosted on the distributed commerce server 150 in one embodiment, over the data network 101 to enable the user to purchase products over the data network 101, or in-store, and, subsequently, be rewarded for this action. The services and processes 103 perform several actions between the merchant systems 105 and the distributed commerce tools 106, between the merchant systems 105 and the databases 102, as well as between the databases 102 and the management tools 104.

The data network 101 may include one or more Local Area Networks (“LANs”), a Wide Area Network (“WAN”) (e.g., Internet Protocol (“IP”) network), and/or mobile/cellular wireless networks connected to one another. Communication/data exchange over data network 101 may occur via any common high-level protocols (e.g., Transfer Control Protocol (“TCP”)/IP, User Datagram Protocol (“UDP”), and so on) and may comprise differing protocols of multiple networks connected through appropriate gateways. This communication/data exchange supports both wired and wireless connections.

The databases 102 may be any data storage device for maintaining product and content data and includes, for example, one or more magnetic disks, optical disks, or network-based storage.

In one embodiment, the management tools 104 include any interface or system that enables the management of the data stored in the database 102. The management tools 104 make use of the services and processes 103 to manage data stored in databases 102.

Services and Processes

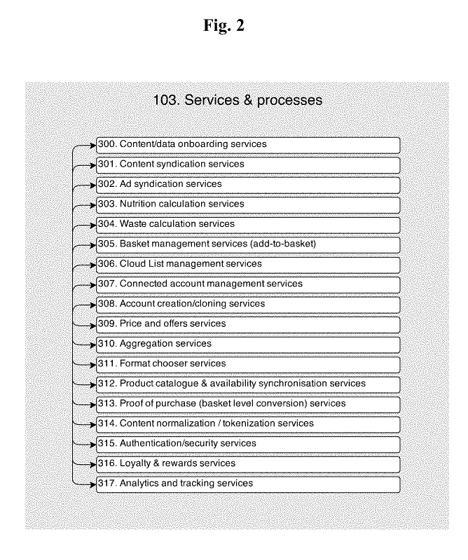

Examples of services and processes 103 are listed in FIG. 2 and are used to communicate and perform calculations over the data network 101, which connects all the components of the system 100, namely the merchant systems 105, the distributed commerce tools 106, the management tools 104 and the databases 102. A more detailed explanation of each of the services and processes 103 and their functions within the system 100 can be found in subsequent sections of this text.

Management Tools

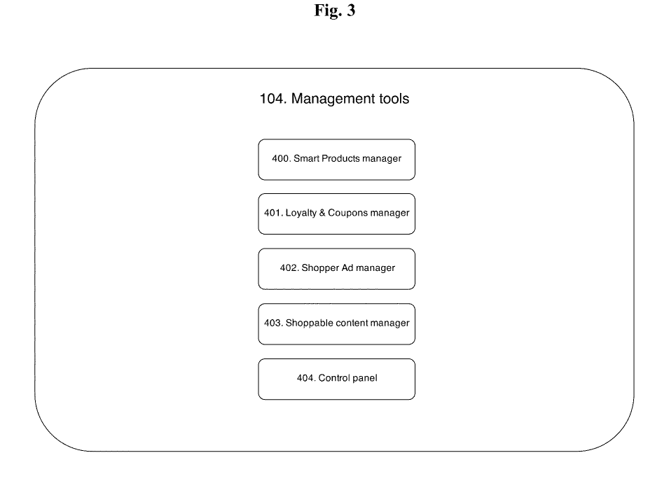

The distributed commerce system 100 helps brands, retailers, and publishers manage their data and content via exemplary management tools 104, as illustrated in FIG. 3, over the data network 101. As shown in FIG. 3, the management tools 104 include a shoppable content manager 403, a shopper ad manager 402, and a loyalty and coupons manager 401 to manage shoppable content, advertisements, coupons, special offers, and services (and any related image and video assets).

The management tools 104 further include a smart product manager 400 for managing the data relating to a specific product catalog maintained in the databases 102. As used herein, the smart products are unique purchasable products (usually associated with a Universal Product Code (UPC) or a European Article Number (EAN)). For example ,Hellmann's® Light Mayonnaise 400 g jar or Rimmel Match Perfection Foundation®—Ivory are sample smart products, which are normalized into the database 102 via a content/data onboarding services 300 (shown in FIG. 2) and managed via the Smart Product manager 400. For each smart product, the distributed commerce system 100 stores detailed product information (often provided by the brand or producer) in the database 102, including a price, special offer, and availability data related to each retailer systems 502 (shown in FIG. 4) where the product is stocked/available for purchase.

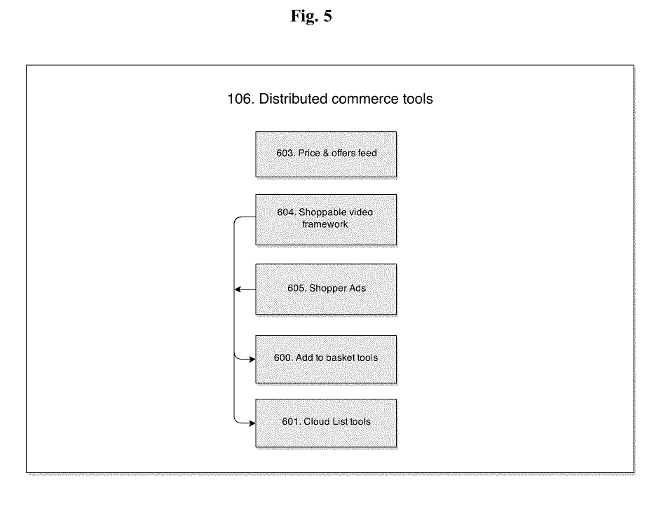

All smart products and other content managed in the distributed commerce system 100 via management tools 104 is made shoppable via services and processes 103 and distributed commerce tools 106, such as an “add-to-basket” 600 functionality, “cloud list” 601 functionality (both shown in FIG. 5) and “shoppable advertising.”

The distributed commerce system 100 provides the management tools 104 for creating e-commerce aware content. These management tools 104 allow partners to create and manage content such as, shoppable recipes, shoppable content, shoppable videos, shoppable product references, and shoppable ads in the database 102, which can then be syndicated across to merchant systems 105 and the distributed commerce tools 106 via content syndication services 301 (shown in FIG. 2) and ad syndication services 302 (also shown in FIG. 2). Furthermore, the management tools 104 allow partners to integrate the content with merchant systems 105 such as ad networks. Content can be on-boarded to the database 102 via the content/data onboarding services 300 and content normalization/tokenization services 314. The content/data onboarding services 300 are used by merchant systems 105 to send existing content to the distributed commerce server 150 for storage in database 102.

In one embodiment, the content normalization/tokenization services 314 use natural language processing, machine learning, and other techniques to identify the shoppable elements of the on-boarded content and map it to the database 102 in a way that makes the content shoppable. A content and administrative team can also manage this content on behalf of its clients. Analytics will be returned to the publishers, retailers, and brands via a control panel 404 based on transactions appropriate to the publishers, retailers, and brands.

Finally, the distributed commerce system 100 can provide rich data and analytics, which can be accessed via the control panel 404. The distributed commerce system 100 maintains a master user record in the database 102 associated to a selected user that will allow the system 100 to store and associate at least one user record and at least one transaction record. In one embodiment, the user record includes the following information for a particular user, for example: a user ID, an e-mail hash, a list of associated cookies, an adID, tokens and sessions, a list of retailer accounts linked to the user, and a list of transactions linked to the user. In one embodiment, the transaction records will include: a Transaction ID, a User ID, a Transaction type (e.g., ad, recipe, bundle), an Associated advertisement/recipe/bundle ID, a list of products, coupons or martProduct IDs added to basket, quantity and/or size data, Transaction status (e.g., pending, confirmed, complete), a Transaction created timestamp, a Transaction updated timestamp, and an Offer expiry timestamp (only if this is a custom offer not a generic limited-time offer with a global expiry).

Merchant Systems

One embodiment of the merchant systems 105 is shown in FIG. 4 and can include any number of computing devices for hosting websites, retail websites, and mobile and tablet applications. As shown in FIG. 4, merchant systems include one or more websites 500, one or more mobile applications 501, and one or more retailer systems 502, each showing the distributed commerce tool 106 embedded within. For example, a consumer viewing a recipe page on one or more websites 500 can easily purchase all of the ingredients needed for the recipe, at a retailer system 502, or in-store at the user's preferred shopping location via a cloud list, through the distributed commerce tools 106.

In another embodiment, the distributed commerce system 100 can make broadcast media 503 content shoppable (via third party services 505 like Shazam® and Zeebox® through the user's tablet device, smartphone, or other device). In one embodiment, the third party services 505 can include any type of third party service, website, application, server or other electronic device or communication tool, which can be used to enable the shoppable content. Similarly, the distributed commerce system 100 can make print media 504, at any scale, shoppable via reference codes or via the third party services 505 (e.g., Blippar® and Aurasma®), which use a device's camera, microphone or other input devices to process the content of the printed material to determine context and link to, or directly provide, distributed commerce tools 106. Thus, the distributed commerce tools 106 allow users to shop from content to a deeper level than previously possible, and reduce the steps needed for users to shop goods and service related to the content they are viewing.

Distributed Commerce Tools

Turning to FIG. 5, an embodiment of the distributed commerce tools 106 is shown, which make content and advertising shoppable in a number of ways. The distributed commerce tools 106 come in the form of embeddable widgets, shoppable advertisements and API's and SDKs (allowing for deeper integrations into merchant systems).

As consumers interact with the distributed commerce system 100, the distributed commerce server 150 learns the context that the commerce takes place, which allows the distributed commerce tools 106 to be tailored to the user, in real-time, via services and processes 103. The distributed commerce server 150 stores user/transaction records discussed above (e.g., a user's information, purchase history, interaction history, preferences, and so on) against the master user record in the database 102. These records are then used to serve targeted distributed commerce tools 106 to the user across merchant systems 105. This data can also be used by the services and processes 103 to provide targeting and personalization of product suggestions, special offers and coupons via the distributed commerce tools 106.

Price and Offers Feed

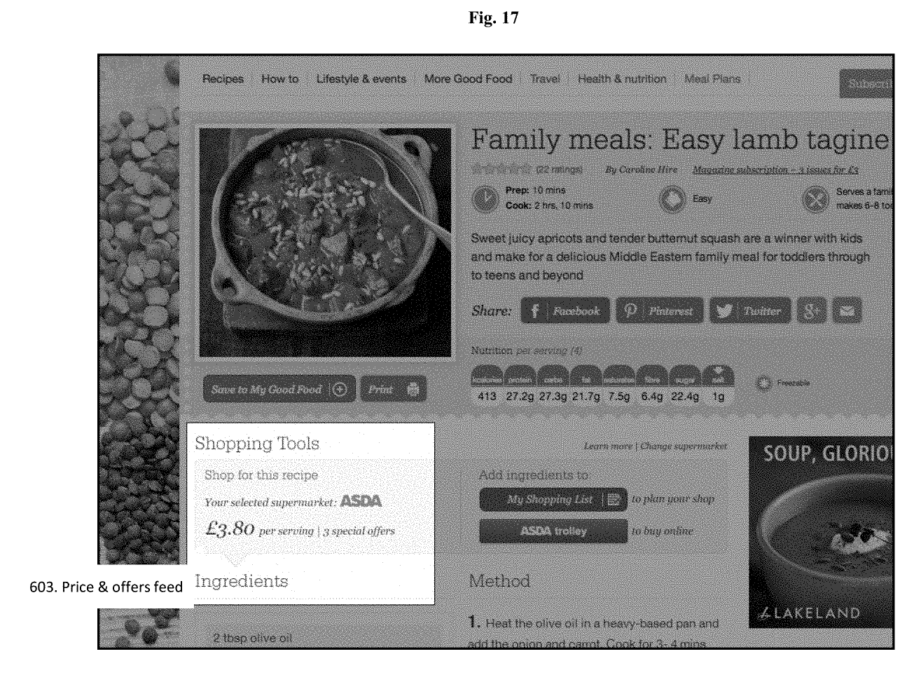

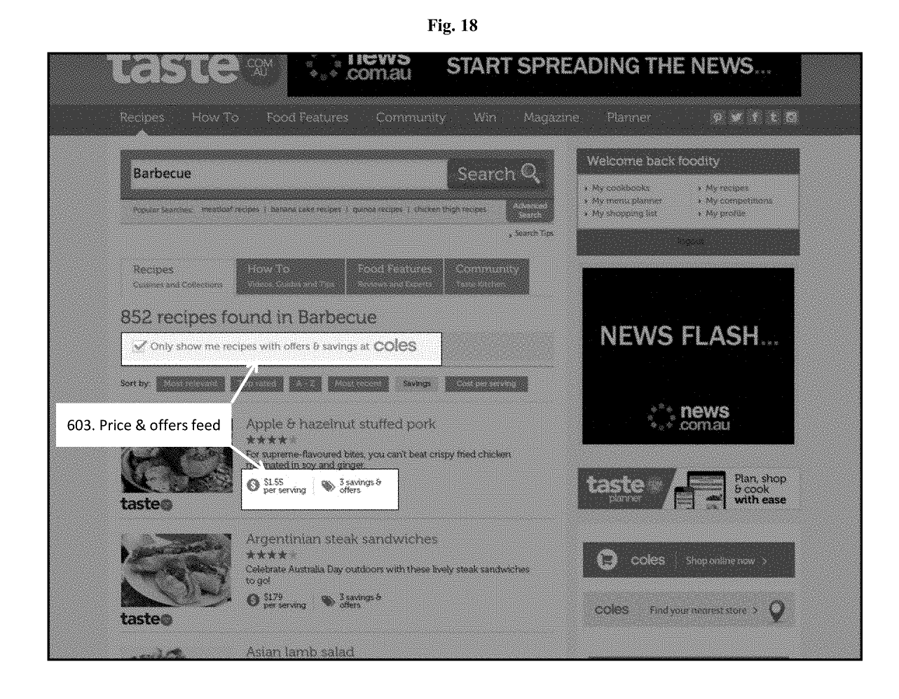

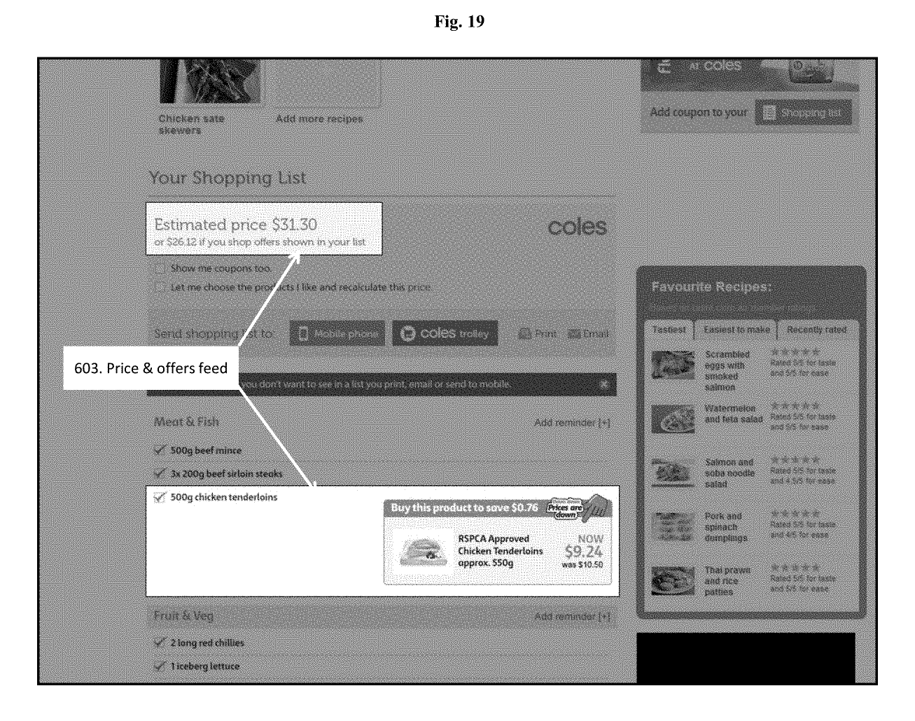

FIG. 17-FIG. 19 illustrate example embodiments of the distributed commerce tools 106 on the merchant system 105 (shown as websites 500) which provide price and special offers, information specific to the products, and special offers available at a particular retailer (including special offers related to hidden SKUs) for one or more pieces of related shoppable content. A price and offers feed 603 uses price and offers services 309 to collect all the product data contained within the shoppable content (for example recipe content, promotional brand content, editorial content, etc.) and compare that to the data provided by product catalogue and availability synchronization services 312 to return the aggregated cost of all the products in the content at a particular retailer as well as surface any special offers (including special offers related to hidden SKUs) that are currently available for those products at that retailer to the user. The product catalogue and availability synchronization services 312 synchronize price data, special offers data, and hidden SKU data for all products between retailer systems 502 and the database 102.

Shoppable Video Framework

The distributed commerce system 100 provides several methods for creating shoppable videos. Video is served into a merchant website 500 or application 501 via a shoppable video framework 604. In one embodiment, the shoppable video framework 604 is embedded in a content network page. The video is displayed within the shoppable video framework 604 with distributed commerce tools 106 such as “add-to-basket” 700 calls-to-action and “add-to-list” 701 calls-to-action. The distributed commerce tools 106 respond to the shoppable video content being viewed so that products featured in the video can be purchased.

In another embodiment, users of video content network pages, such as a ‘YouTube® Gadget’ page are presented with three elements to the page: a video player, a video navigation pane, and distributed commerce tools 106. The user can use the video navigation pane to select a video to view. Selecting a video launches that video in the video player and loads the related distributed commerce tools 106. The distributed commerce tools 106 (shopper interfaces) display product suggestions that are relevant to the products featured in the video so that they can be purchased.

In yet another embodiment, a video is embedded in a webpage on a website 500 or application 501. The video is served surrounded by a container with distributed commerce tools 106. Shoppable elements featured in the video have a time code assigned to them. The distributed commerce tools 106 can be set up so that when the time code is reached while the video is playing, it triggers an action in the distributed commerce tools 106 which enable the related product to be purchased.

In another embodiment, a video is a media component in a larger web page. The video is filmed so that elements of the video overlap a central frame of the video. The central frame is visible in the video and acts as a display area for the elements that are featured in the video. When an element passes outside the central frame this triggers an animated element in the larger web page that is synchronized with the video. This allows the element to be seen to pass from the video on to the larger page. The larger page features distributed commerce tools 106, which allows products featured in the video to be purchased.

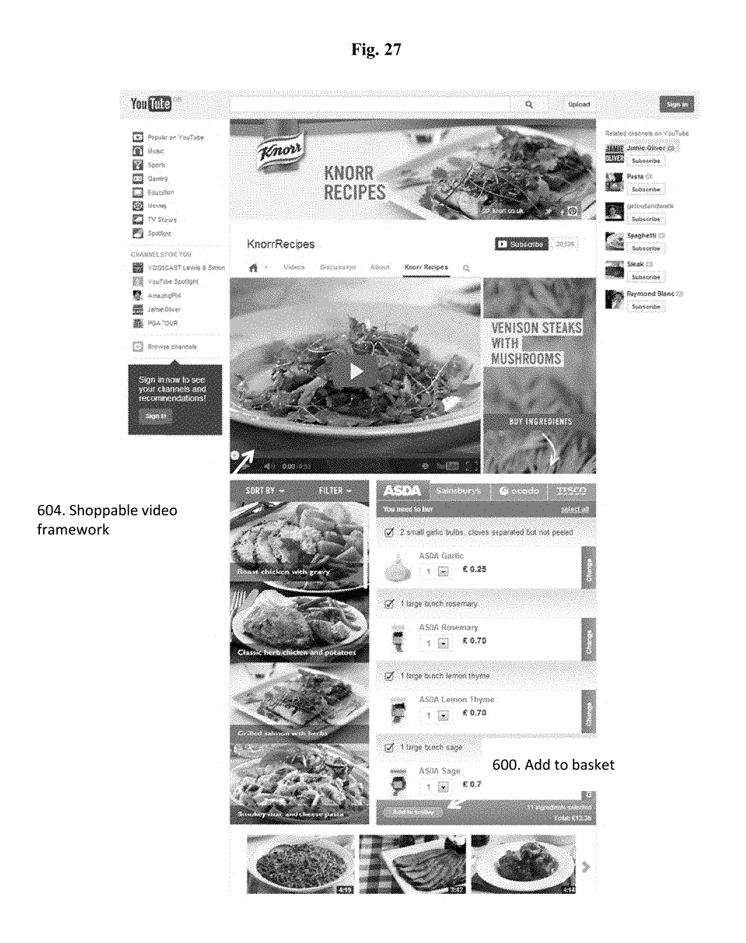

FIG. 27 shows a shoppable video framework 604 embedded into YouTube®, a merchant system 105 where the video is embedded and the related ingredients can be purchased via the distributed commerce tool 106 below the video player.

Shopper Ads

Distributed commerce tools 106 can come in the form of shopper ads 605 that are found on the merchant systems 105. These shopper ads 605 can either be ad units that are powered by the system 100 and embedded in an ad space on the merchant system 105 or they can be interactive widgets that are embedded within other ads on merchant systems 105. Shopper ads 605 can take different formats that include, but are not limited to, basic ads, browsable ads, interactive voting ads, real-time special offer ads.

Basic ads are the simplest form of shopper ads 605 that allow users to add a single featured product, or a bundle of products to their basket or to their shopping list. They can feature a product to be shopped at a single retailer or multiple retailers of choice. Browsable ads allow users to interact with the ads to discover more product details or choose between a number of pre-selected products or bundles of products, before adding to their basket or their shopping list. Interactive voting ads also require a level of interaction from the user. They allow users to vote for their favorite featured products before presenting them with the social results of the campaign and actions to allow them to add the product(s) to their basket or their shopping list.

Real-time special offer ads are automatically generated so that they feature all a retailer's top offers across the whole store or across a particular category. These dynamically update as offers change. These real-time special offer ads could feature either single product offer ads or multi-offer ads depending on whether the special offer at the retailer relates to a single product or a selection of products that requires the user to interact with the ad first. The user then either sends the product(s) to their basket or to their shopping list, where the special offer price is also captured.

Add to Basket

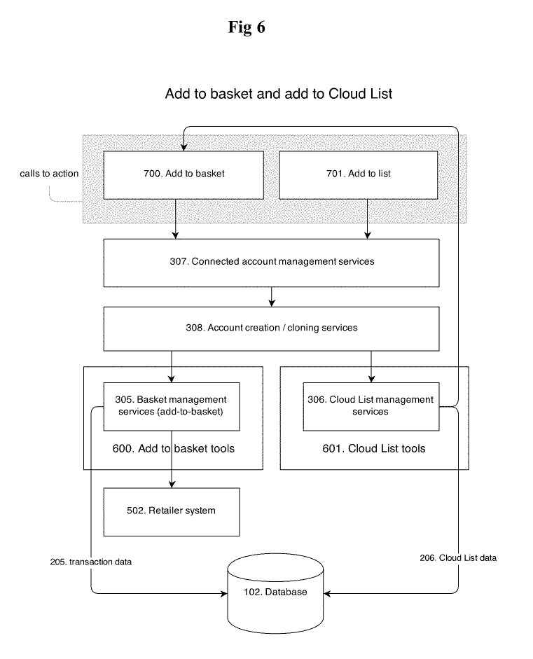

With reference now to FIG. 6, as users interact with the distributed commerce tools 106 within the merchant system 105, “add-to-basket” tools 600 can be used to add one or more products remotely to a user's e-commerce accounts at the retailer system 502. “Add-to-basket” tools 600 are triggered when a user clicks on an “add-to-basket” trigger 700 or an “add-to-list” trigger 701. For example, single product “add-to-basket” buttons are generally used for “smart products” and in some embodiments take the form of “buy now” buttons on brand websites, promotional content, or in advertisement units. Multi product “add-to-basket” buttons are used to add a bundle of products to a user's basket. Examples of bundles of products related to content include, but are not limited to: an ingredient list for a recipe or multiple recipes; an editorially defined list of products to support an ad or content; or a bundle of products arrived at algorithmically in an interactive advertisement, web application, or mobile application.

Cloud List

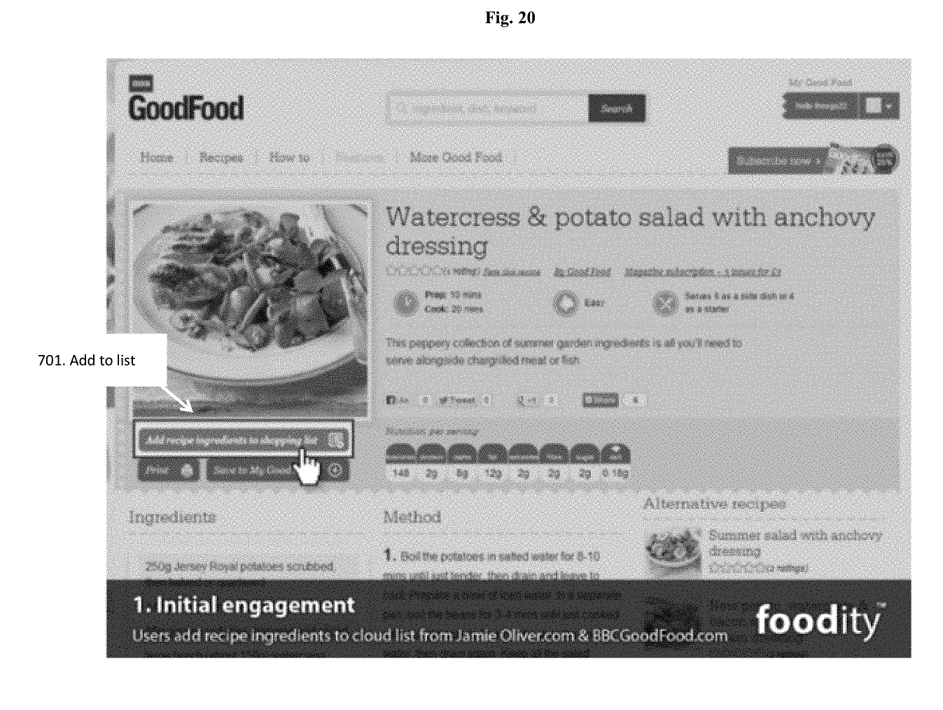

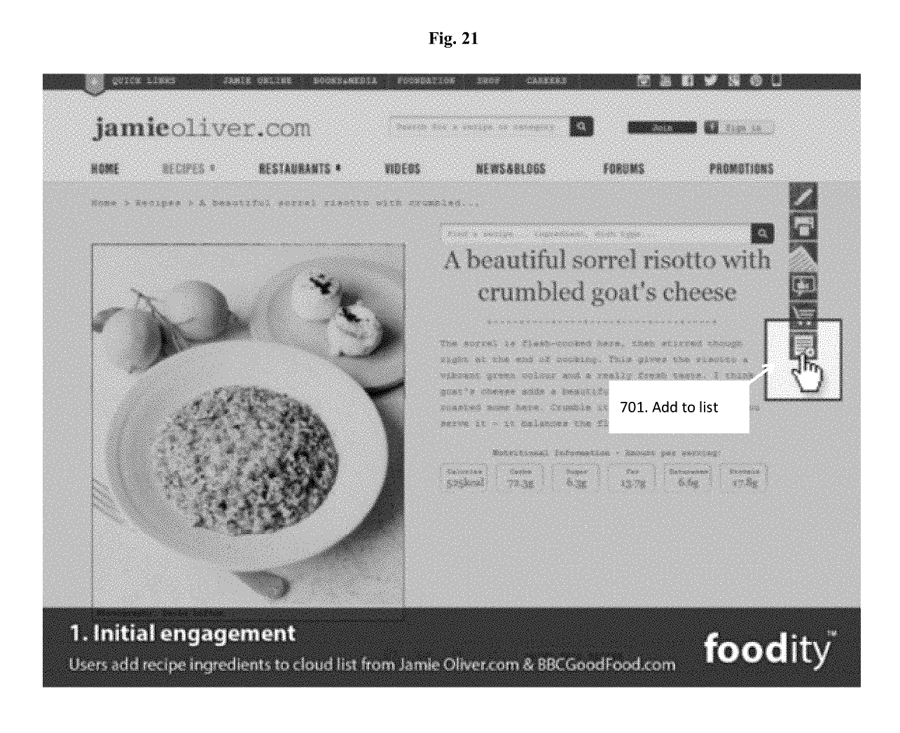

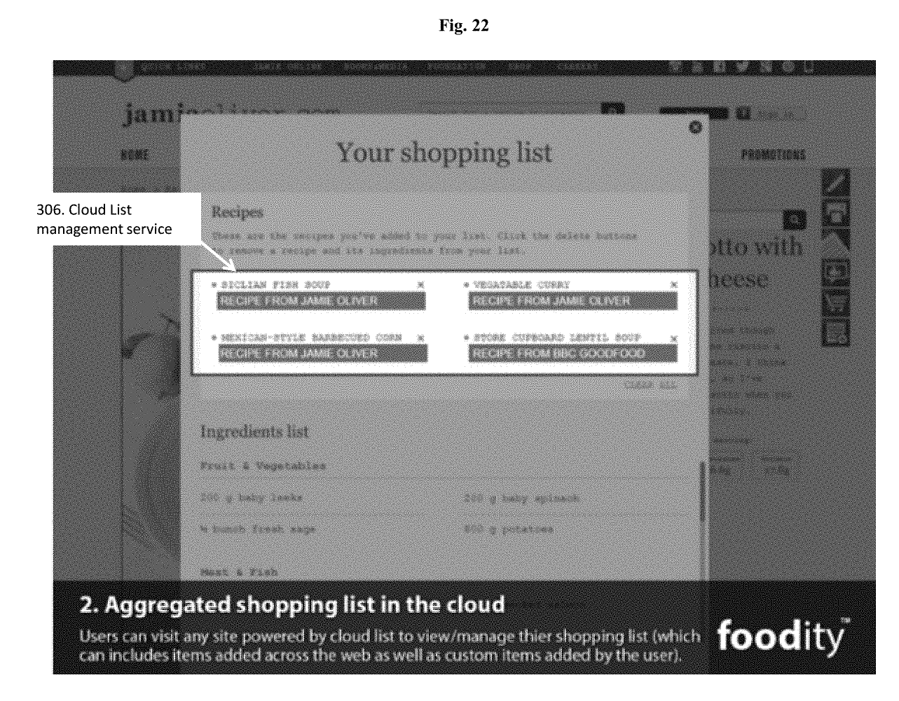

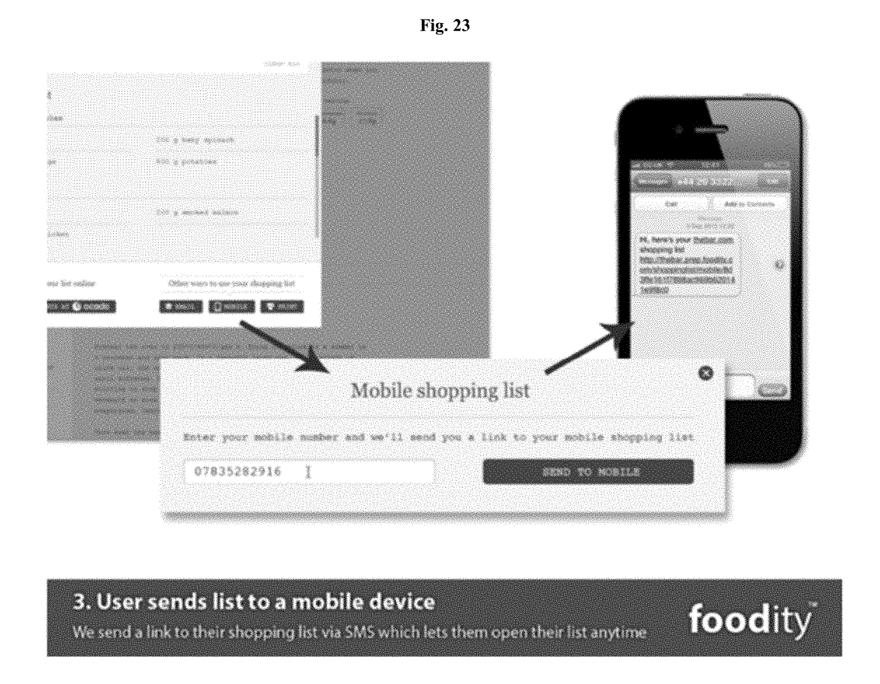

As briefly described above, a “cloud list” is an aggregated list of products and coupons that is managed by cloud list management services 306 and associated with the master user record in the database 102. The cloud list management services 306 connect the distributed commerce tools 106 and the database 102 via the data network 101 and provide the management of a “cloud list.” Cloud lists can then be accessed and managed on cloud list tools 601 in merchant systems 105 via the cloud list management services 306 over the data network 101. In one embodiment, cloud lists are independent of merchant systems 105, but their content (i.e., the products and coupons) is collected by the user's interactions with distributed commerce tools 106 on various merchant systems 105. In one embodiment, shown in FIG. 20-FIG. 21, the process of using a cloud list starts with initial engagement from the user. For example, a user may add recipe ingredients to a cloud list via the distributed commerce tools 106 on a number of merchant systems 105. Users can visit any merchant system 105 that is powered by cloud list tools 601, to view/manage their shopping list, shown in FIG. 22 (which can include items added from different merchant systems 105 as well as custom items added by the user). Users may then send the cloud list to a mobile device or their cloud list can be synchronized with a retailer's app 502, as shown in FIG. 23. The system 100 sends a link to the user's cloud list via SMS or other communication medium, which allows the user open their cloud list anytime.

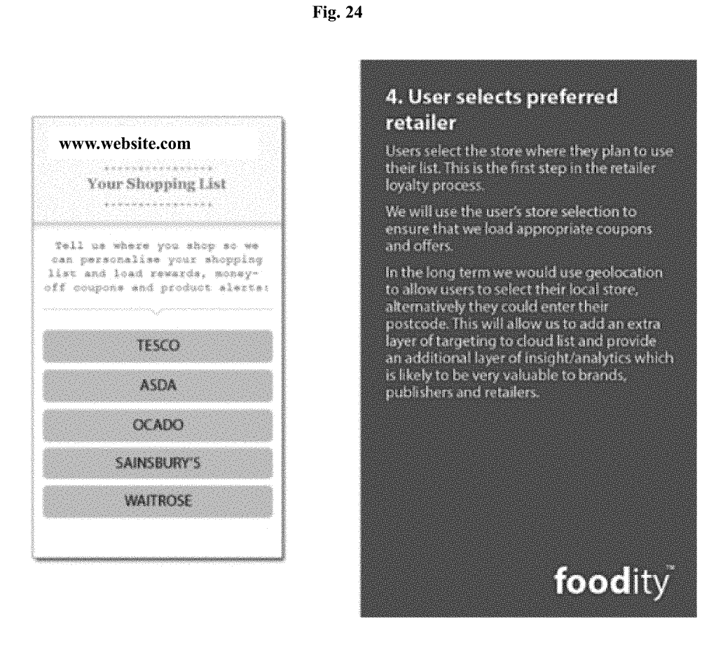

The user may select a preferred retailer, as shown in FIG. 24. Users select the retailer where they plan to use their cloud list. This is the first step in the retailer loyalty process. The system 100 uses the user's retailer selection as well as the user's preferences, transaction history and any related products in their list to ensure distributed commerce tools 106 across merchant systems 105 load appropriate and targeted coupons and offers to that user. The system 100 may also use geolocation to allow users to specify their local retailer store, or they can enter a postal code or other location service. This allows the system 100 to add an extra layer of location-based targeting to the coupons pushed to the user via the loyalty and reward services 316 and distributed commerce tools 106 on merchant systems 105 and provide an additional layer of insight/analytics data in the database 102 that is likely to be very valuable to brands, publishers, and retailers.

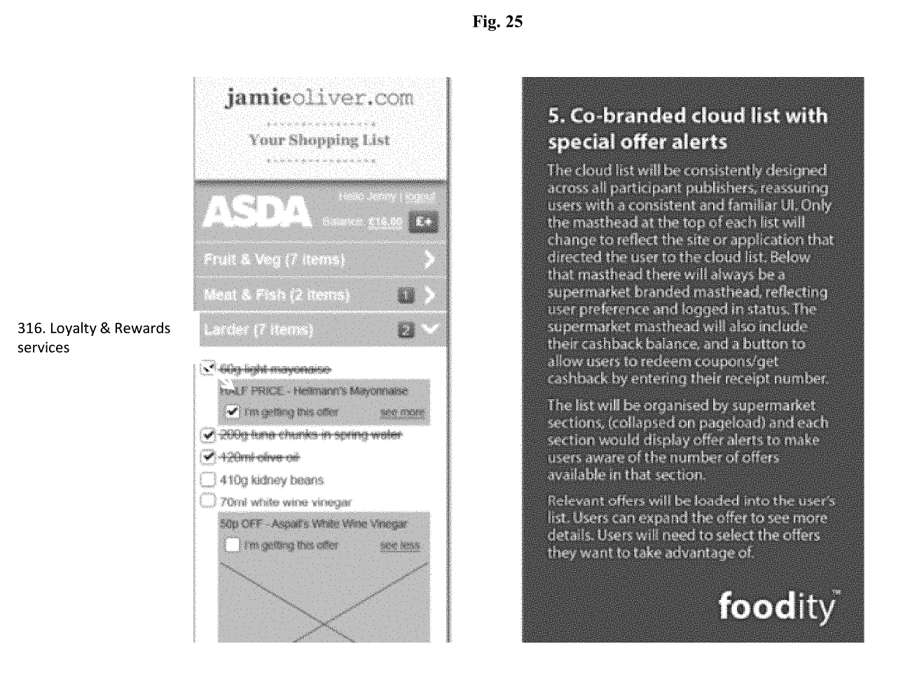

In some embodiments, the cloud list tools 601 are consistently designed across all participating merchant systems 105, reassuring users with a consistent and familiar user experience. When the cloud list tools 601 are viewed in a website 500 or application 501 the masthead at the top of each list may change to reflect the merchant system 105 that directed the user to the cloud list. Below the masthead cloud list functionality relates to the retailer system 502, reflecting user preference from the database 102 and logged in status via the connected account management services. In some embodiments, a retailer may not be indicated. The cloud list tools 601 can include the user's cash back balance, provided by the loyalty and rewards services 316, and a mechanic by which a user can enter a unique transaction reference 202 to validate the purchases they have made and get rewarded with cash back or loyalty points via the loyalty and rewards services 316. The cloud list is organized by supermarket departments and each department displays offer alerts and coupons served by the loyalty and rewards services 316 and format chooser services 311 to make users aware of offers and coupons available in that department, as shown in FIG. 25. Offers and coupons can also be targeted to a user via the cloud list tools 601 based on the items in the user's cloud list. Users can expand an offer to see more details and select the ones that they want to take advantage of

In some embodiments users can add custom items and reminders to their list. These custom items can include product formats from a retailer system 502 or free format text which can be interpreted by the content normalization/tokenization services 314 so that the system 100 can return product suggestions to the user via the format chooser service 311.

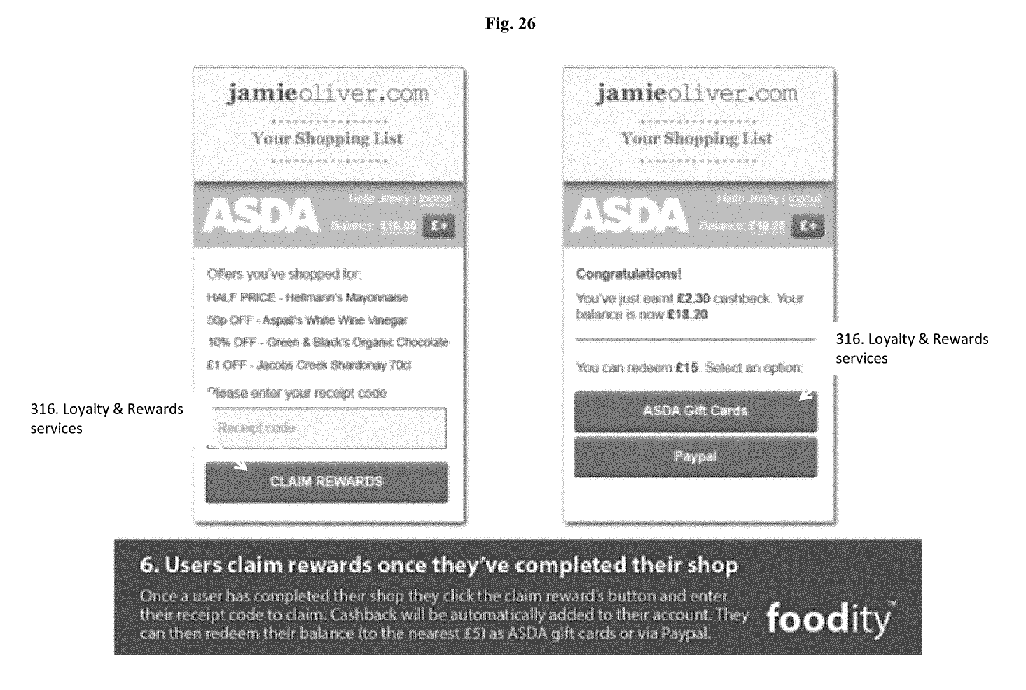

Once a user has completed their transaction, they can initiate the coupon redemption process, as shown in FIG. 26, within the cloud list tools 601 by entering a unique transaction reference 202. The proof of purchase (basket level conversion) services 313 uses this reference 202 to request transaction data 203 from the retailer systems 502 and posts a message to the loyalty and rewards services 316 detailing precisely which products were purchased. The loyalty and rewards services 316 then verify whether the transaction qualifies for any loyalty or rewards redemptions. If it does qualify, cash back or another form of reward, will be automatically be associated with the master user record in the databases 102. The user can then redeem the balance (e.g., to the nearest $1). In one embodiment, this is claimed as retailer credit or loyalty points, but other redemption methods are possible in other embodiments such as via retailer gift cards, PayPal®, or by other suitable means.

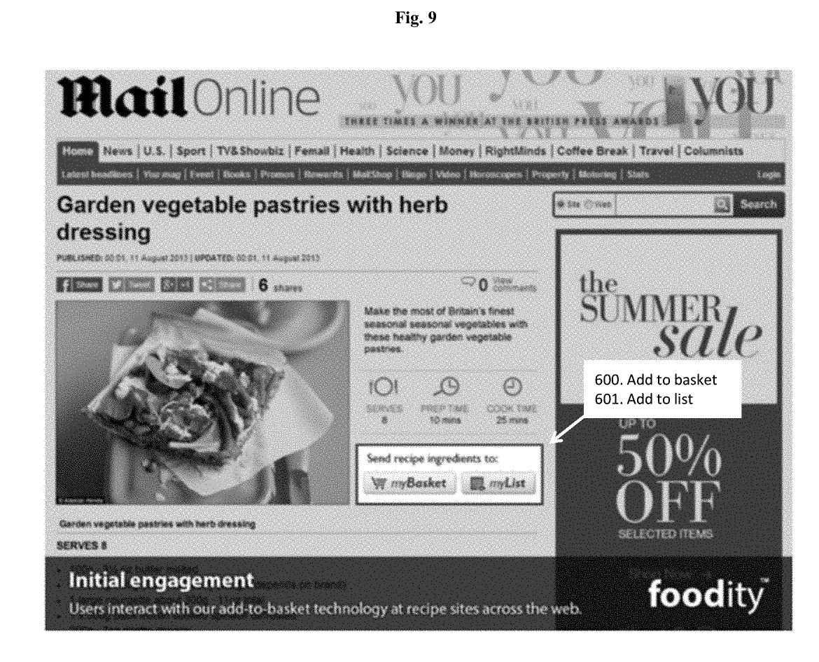

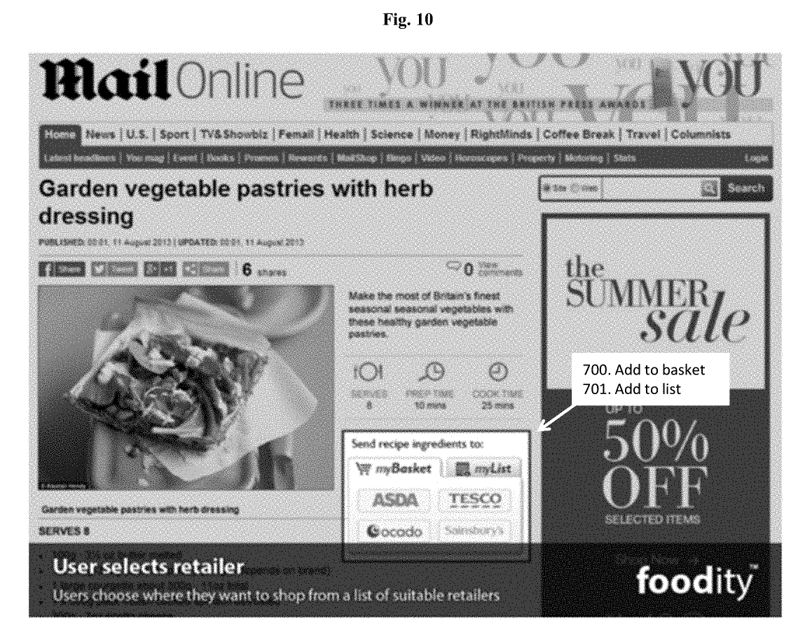

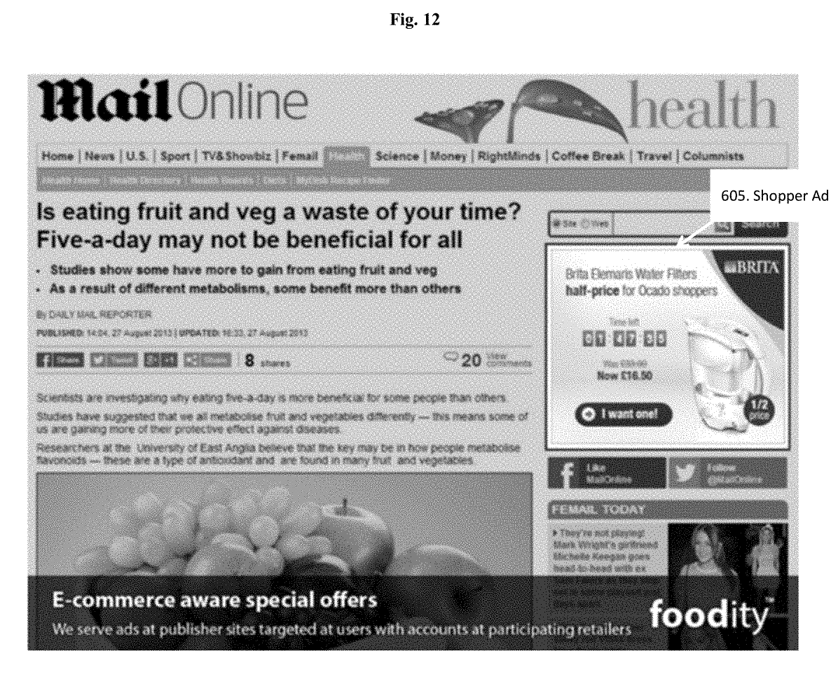

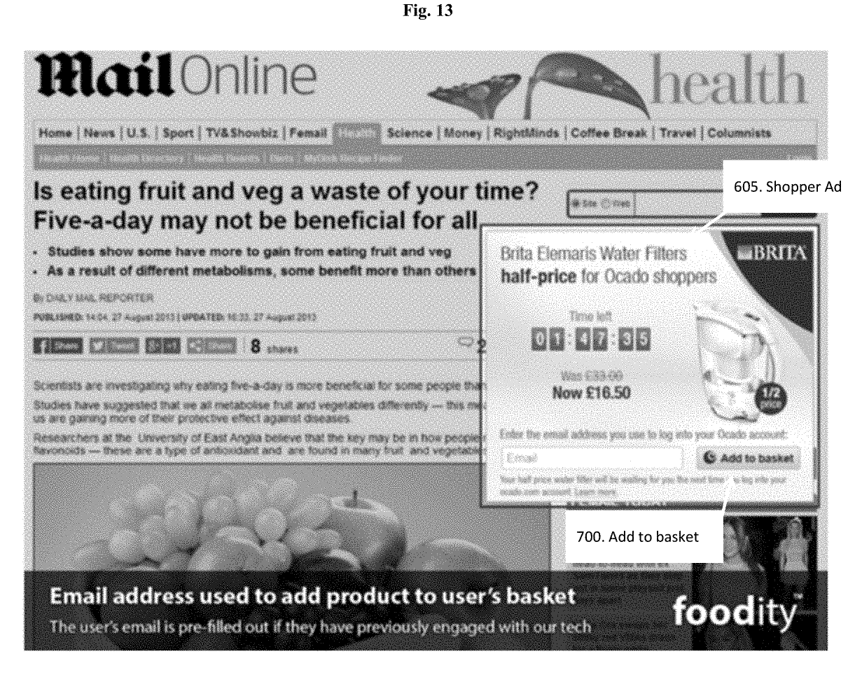

Turning to FIG. 9-FIG. 16, one embodiment is shown where distributed commerce tools 106 are integrated into merchant systems 105 (such as webpages, applications, etc.). The user's first encounter the functionality of the distributed commerce system 100 via “add-to-basket” triggers 700 and “add-to-list” triggers 701 that relate to shoppable content (recipe content, promotional brand content, editorial content etc), and advertising etc. The distributed commerce tools 106 are integrated by including a short script (provided by the system 100) into their code which points to a JavaScript file or other services on the system's servers, plus a line of code where they want the buttons to appear. On page load, the script calls the system's JavaScript framework, which speaks to the services and processes 103 in the system 100 to authenticate the request, and then automatically loads the relevant functionality into the page using iframes and overlays/lightboxes. In another embodiment these tools are integrated directly into the merchant systems using APIs provided as part of the distributed commerce tools 106. In another embodiment these tools are integrated via SDKs provided as part of the distributed commerce tools 106.

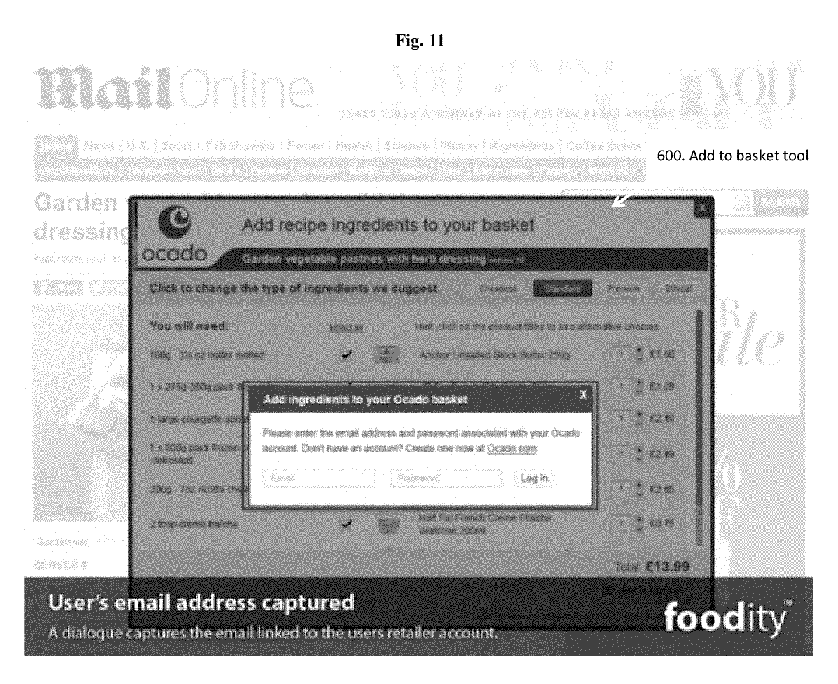

When a user interacts with a distributed commerce tool 106 at any merchant system 105 for the first time, or using a new device/browser with no tracking cookie present, the user will be presented with, and need to select from a list of appropriate retailers. The system 100 uses the connected account management services 307 to establish whether a user is a first time user or using a new device/browser. The connected account management services 307 is used to enable a connected and personalized experience of the distributed commerce tools 106 across all merchant systems 105 for a user by connecting the user's accounts (retailer and publisher accounts for example) with a master user record in the database 102 as well as creating a browser session, dropping cookies or tokens (for example) relating to this master user record on merchant systems 105. If a user is identified as a new user a new master user record is created in the database 102. This new master user record can be connected to an existing master user record at a later stage if appropriate. The connected account management services 307 are then used to personalize the distributed commerce tools 106 according to the preferences or previous actions associated with the master user record. The system 100 serves up the appropriate distributed commerce tools 106 in the form of the “add-to-basket” tool 600, which returns product suggestions and price information, as is shown in FIG. 11.

Many of the distributed commerce tools 106, such as add to basket tools 600, cloud list tools 601, shoppable videos 604 and shopper ads 605 serve product suggestions to a particular user which can be targeted depending on the type of content they are viewing, or the particular distributed commerce tool 106 they are using. In order to ensure the most accurate and appropriate product suggestions are returned to the user the system 100 makes use of the aggregation services 310 and format chooser services 311 amongst other services and procedures 103. The aggregation services 310 automatically determine and combine duplicate or similar items within a bundle of products to output a new combined quantity of the desired products. This output is then fed into the format chooser services 311 which then returns the most appropriate retailer product formats. The format chooser services 311 identify the suitability of retailer product formats stored within our database 102 based on several factors including the product association, size, wastage calculations (provided by the waste calculation services 304 computing the amount of a product that would be wasted if a certain product size was purchased given the amount that is actually needed by the user), special offers (including special offers related to hidden SKUs), product categorizations (such as the most affordable products, the most popular products, the best quality products and the most ethical products etc). If the user has a master user record in the database 102, the format chooser services 311 also takes into account the user favourites, the user preferences, nutrition calculations based on the user dietary requirements (provided by the nutrition calculation services 303 computing various nutritional stats from the products), how the user has interacted with other distributed commerce tools 106 in the past. With all of these inputs, the format chooser services 311 are then able to algorithmically calculate the most suitable product suggestions for a user and these are returned to the distributed commerce tools 106 on merchant systems 105. Within the distributed commerce tools 106 users are able to customize the product suggestions by choosing from a number of product categories, or changing individual product choices by viewing alternative product suggestions which are returned by the format chooser services 311.

The user selects the product(s) they wish to add to basket and clicks a button to confirm that they wish to add the products to basket. They are then asked to enter the e-mail address that they use to log into their account at their chosen retailer. If the user does not have an account the system 100 can create one for the user via the account creation/cloning services 308.

The connected account management services 307 creates a hash of the user's e-mail address and uses it to query the database 102 to see if the address has been previously used to add products to this user's retailer (or any other retailer) basket or to add products to a cloud shopping list via any device or merchant system 105 featuring any of the distributed commerce tools 106 (advertisements, video framework etc.). If a hash of the user's e-mail address exists in the database 102, a cookie is dropped on the user's device that is linked to a master user record in the database 102. If the user's e-mail address does not already exist in the database 102 then a new master user record is created and a cookie is dropped on the user's device.

For existing users that already have a cookie on their browser/device when the distributed commerce tools 106 load on merchant systems 105 the following will happen: The cookie will be used by the connected account management services 307 to identify the retailers with which the user has an account. If the merchant system 105 is loading shoppable videos 604 or shopper ads 605, it will load appropriate content based on the retailers the system 100 knows the user has (e.g., 50% off for Ocado shoppers). If a merchant system 105 loads content that is available at multiple retailers, the retailer at which they have an account will be pre-selected for the user, thus making the process to open the add-to-basket tool 600 happen at a single click without the need to select a retailer. If a user has more than one suitable account then the account that was most recently used for an “add-to-basket” transaction via the basket management services 305 will be the default choice. The user will not be required to enter the e-mail address for their account; instead, they will just need to confirm the e-mail address, which will be pre-populated when the content loads. Users can choose to switch retailer, or click a link to “forget me,” which will update or remove the tracking cookie accordingly and the related information in the database 102. The user can then choose to use a different e-mail address. This will update or remove the cookie accordingly and the related information in the database 102. Some embodiments may also rely on password input.

Once a user's account details have been input the product, or bundle of products are sent to the user's basket at a retailer system 502 via the basket management services 305. The basket management services 305 communicate with the relevant retailer system 502 via an application programming interface (API) or via virtual session technology (whereby a programmed headless browser is used to perform all the actions in a user session at the e-commerce site that are required to achieve the desired end), to send through an identifier for the transaction, the user's e-mail hash, and the IDs and quantity/size information for each of the products they wish to add to basket (and where appropriate a list of recipe titles, content references, and/or ad titles). The items can be added to basket in a pending state awaiting approval by the user when they next log in, or can be committed to basket without a requirement for user approval. The transaction data is also stored in the database 102 and is associated with the user via their e-mail hash.

When a user adds products to a basket via the basket management services 305 the system 100 keeps a user's shopping session open for a period of time, so that the user can add products to basket instantly without the need to provide their email address and/or password a second time.

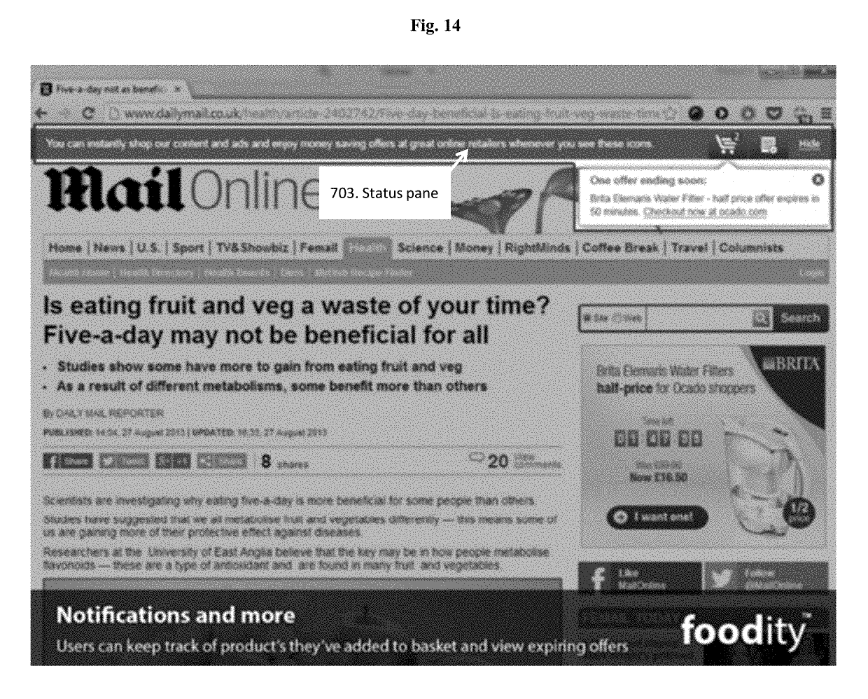

Next is the process for providing reminders, completing the transaction, and closing the loop. The transaction data 205 that is stored in the database 102 contains a status (e.g., “pending,” “confirmed,” “complete”) and a link to the shoppable content (ad, recipe, video etc.) on the merchant systems 105 with which the shopper interacted. In one embodiment using this data 205 the system 100 can display a summary of the user's transactions to them via a distributed commerce tool 106 in the form of a status pane on any merchant system 105 as shown in FIG. 14. If one of the products they have added to their retailer basket is on a limited time offer, or if it is a coupon with a limited expiry, the system 100 can return alerts/reminders to the distributed commerce tools 106 with a countdown until the offer expires. In other embodiments, notifications about expiring special offers (including special offers related to hidden SKUs) can be pushed to a user's mobile phone or other devices via merchant systems 105. A user can hide the status pane, shown in FIG. 14, or choose to be forgotten, in which case the system 100 will update/delete the user's cookie on that device/browser and the connected account management services 307 will modify the master user record in the database 102 if required.

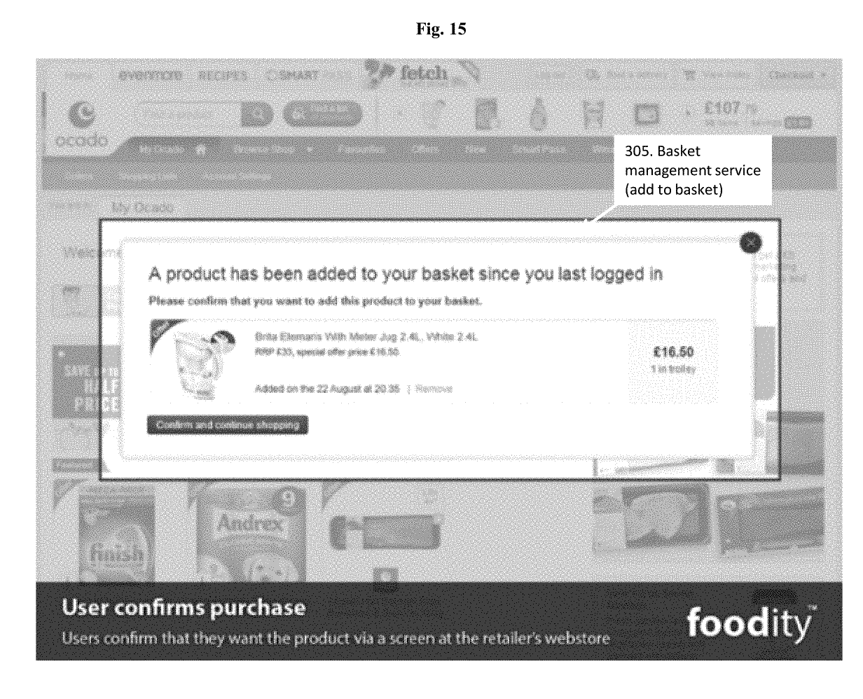

In one embodiment, when a user logs into their retailer account on a retailer system 502, the distributed commerce tools 106 can return a notification of any products that have been added to the retailer basket since they last logged in, in which case they will need to confirm that they want these products to be added to their retailer account, as shown in FIG. 15. In the case of a single product having been added to basket, the product title will be listed. In the case of a recipe or bundle of ingredients having been added to basket, the recipe titles and/or bundle title will be listed with an option to see a full list of all the pending products they have added to basket. Once the user clicks to confirm that they wish to add the products to basket, the retailer system 502 will send a status update in the form of retailer transaction data 203 to the proof of purchase (basket level conversion) services 313 to change the transaction status from “pending” to “confirmed” in the database 102. When a user completes their transaction via checkout 506, the retailer system 502 will send another status update in the form of retailer transaction data 203 to the proof of purchase (basket level conversion) service 313 to change the transaction status to “complete” in the database 102. This will then allow the system to update the reminders shown to the user when they encounter distributed commerce tools 106 on any merchant system 105.

The system 100 provides account creation/cloning services 308 for account linking and account cloning of retailer accounts. Retailer accounts are any account created for the purpose of commerce or loyalty for use with, or via, a retailer system 502. In other embodiments, the system 100 can also create other types of accounts relating to merchant systems 105.

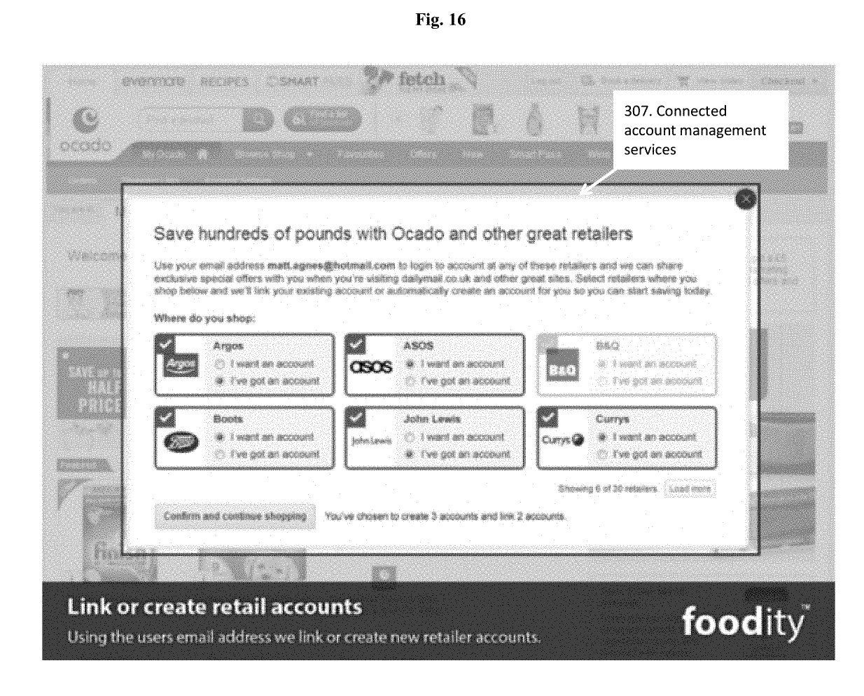

In one embodiment, shown in FIG. 16, once a user has confirmed that they want the products to be added to their basket, they are then shown the option to associate other retailer accounts with this account, or to create new retailer accounts which will be a clone of their existing account. Users can select the retailers at which they have accounts using the same e-mail address, or they can select retailers where they would like to have an account created using the same e-mail address. When a user wishes to link their accounts, a request is made via the connected account management services 307 which will link the accounts for each of the selected retailers to the master user record in the database 102, using the email hash.

If a user selects the option to create new accounts, the referring retailer system 502 will send a request via the connected account management services 307 to the retailer systems 502 at which the account needs to be set up. The request will include all the data (encrypted) required for them to set up the account. The connected account management services 307 use the e-mail hash provided to link the newly created retailer accounts to the master user record in the database 102.

In another embodiment, a user can provide the account details they would like to use via one of the distributed commerce tools 106. The account details are passed to the account creation/cloning services 308 which communicates with the relevant retailer system 502 via an application programming interface (API) or via virtual session technology (whereby a programmed headless browser is used to perform all the actions in a user session at the retailer system 502 that are required to achieve the desired end). Identifying information (like an e-mail hash and retailer id) relating to the new accounts created by the account creation/cloning services 308 are automatically recorded in the database 102 by the connected account management services 307 and are associated with an existing master user record and any relevant sessions, devices and cookies where appropriate.

Returning to FIG. 6, there are two main types of call-to-action to make content and ads shoppable via the distributed commerce tools 106 “Add-to-basket” 700 calls-to-action allow the customer to send all or some of the items related to the underlying content (e.g., each of the ingredients for a recipe) to an e-commerce basket via distributed commerce services and processes 103. “Add-to-list” 701 calls-to-action allow the customer to add all or some of the items relating to the underlying content to a network-based (e.g., cloud-based via cloud computing) cloud shopping list for a chosen retailer. The cloud list 601 provides an aggregated shopping list based on the products, services, special offers and coupons they have added to their list from content and advertising via distributed commerce tools 106 at any merchant system 105. Users can visit any website 500 or their chosen retailer's website or app 502 which includes the distributed commerce tools 106 to view and manage their cloud shopping lists.

Proof of Purchase (Basket Level Conversion) Services

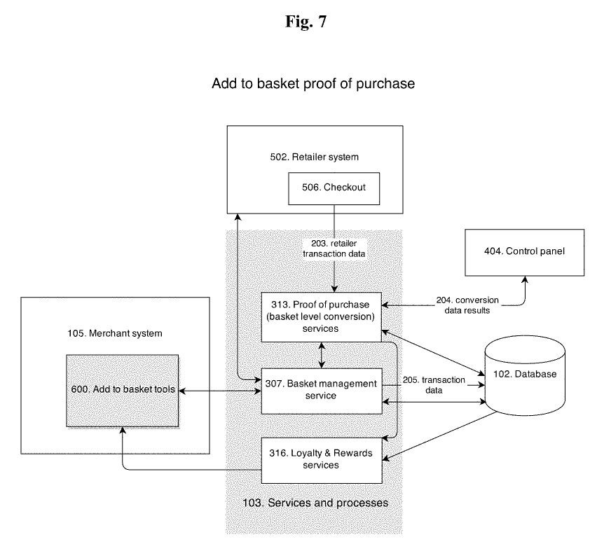

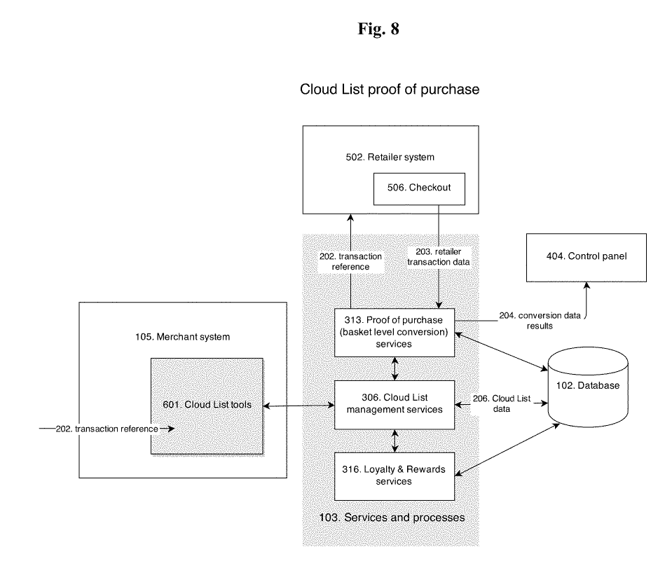

Turning to FIG. 7 and FIG. 8, the proof of purchase (basket level conversion) services 313 are secure services that allow the system 100 to validate a purchase completed via retailer systems 502, which was triggered by one of the distributed commerce tools 106. This allows the system 100 to connect a purchase back to the shoppable content, recipe, brand campaign, shoppable advertisement, shoppable video etc. that inspired the purchase. It is able to do this by recording all events and actions related to the distributed commerce tools 106 as analytics and transaction data 205 in the database 102 and comparing this with retailer transaction data 203 provided by the retailer system 502.

Proof of Purchase (Basket Level Conversion) Services for Add to Basket

Turning to FIG. 7, proof of purchase (basket level conversion) services 313 are the mechanics by which we can track and attribute the result of user interactions with the add-to-basket tools 500 and their conversion into a completed transaction at an online retailer system 502.

When a user interacts with the distributed commerce tools 106 embedded in one of the merchant systems 105 and chooses to send one or more products to their online retailer shopping basket, the basket management services 305 sends the products to the retailer system 502. In one embodiment a unique transaction id can be sent to the retailer system 502 by the basket management system 305 to be later used to help identify corresponding purchases. In another embodiment the system 100 makes use of the user's email hash to identify and validate completed purchases.

Once the checkout 506 is completed, the retailer system 502 sends the transaction data 203, including the user's email hash, or the transaction ID 202 to an endpoint provided by the system 100. The retailer will return this data in machine-readable format including Product IDs and quantities, hashed User IDs, and Timestamps (and where appropriate the transaction reference 202). To avoid processing a checkout 506 that is not linked to the system 100, the basket information is screened by a filter within the proof of purchase services 313. The filter will only allow relevant data to be processed for basket level conversion purposes and reject all other data. The filtering is handled by an algorithm running on the proof of purchase services 313.

The proof of purchase services 313 compare the filtered retailer transaction data 203 with the original transaction data 205 and sends proof of purchase data to the database 102.

In another embodiment, the retailer will send status updates about items in a user's basket to the proof of purchase services 313, which update the status of the related records in the database 102. The status can include “pending”, “confirmed” and “complete” which means that the item has been transacted.

Proof of Purchase (Basket Level Conversion) Services for Cloud List

Turning to FIG. 8, proof of purchase services 313 are the mechanics by which we can track and attribute the result of users converting their cloud shopping list into a completed transaction via a retailer system 502.

A user browses various merchant systems 105 which host the cloud list tools 501. As the user adds various products and bundles of products to the cloud list, a request is made to the cloud list management services 306 to store the products against their master user record in the database 102.

Once a user purchases some or all of the products via an in-store checkout 506, the retailer system 502 will provide a printed receipt, or a digital equivalent which will provide a unique transaction reference 202. This transaction reference 202 can be entered into the cloud list management tools 501 from any merchant system 105.

The cloud list tools 501 communicate with the cloud list management services 306, passing the transaction reference 202. The cloud list management services 306 in turn pass it to the proof of purchase services 313.

The proof of purchase services 313 request transaction details from the retailer system 502 by passing the transaction reference 202 to an endpoint on the retailer system 502. If found, the retailer system 502 returns the related transaction data 203 (including the product IDs and quantities) in a machine readable format to the proof of purchase services 313.

To avoid processing any checkout data that is not linked to the system 100, the transaction data 203 is screened by a filter within the proof of purchase services 313. The filter will only allow relevant data to be processed for basket level conversion purposes and reject all other data. The filtering is handled by an algorithm running on the proof of purchase services 313.

The proof of purchase services 313 can then product-match and analyze the user's cloud list against the purchased product, and sends proof of purchase data to the database 102.

By confirming conversions via the proof of purchase (basket level conversation) services 313, the merchant (at merchant system 105) can increase volume of purchase, by optimizing basket conversion, gain basket level insight, and share basket level conversion data with brands on a commercial basis. Advantageously, this kind of transparency and control over the consumer journey encourages brands and publishers to prefer participating retailers for their referrals, and will push more consumers towards participating retailers and increase revenue.

The proof of purchase basket level conversion) services 313 are a secure solution for determining basket level conversion. They may not be a database or a tool, but may simply generate reports based on the input data—this ensures that the data is secure and anonymous. The data passed includes, but is not limited to, product IDs and quantities, Publisher/Campaign ID, a hashed function of the User ID, and the Timestamp.

The control panel 404 in FIG. 7 and FIG. 8 will provide partners with access to the analysis of the conversion data results 204 produced by the proof of purchase (basket level conversion) services 313. Once retailer checkout data (in-store or on-line) 203 is passed to the proof of purchase services 313, an algorithm is executed on the data to filter out all checkouts which were not referred to the retailer by the system 100 originally. The proof of purchase (basket level conversion) services 313 process the remaining retailer checkout data 203 against the platform data stored in the database 102 to couple sets of data that relate to the same transaction. This process generates basket level conversion data, which is then stored in the database 102 and displayed in the proof of purchase control panel 404.

The proof of purchase services 313 ensure that only data relevant to the retailer is passed to the control panel 404. The proof of purchase control panel 404 will display basket level conversion (i.e., the percentage of Add-to-Basket requests that are checkout out at Retailer) for baskets and products; total checked out Add-to-Baskets; total value of checked out Add-to-Baskets and the ratio of new clients to repeat clients. It will also be possible to report on individual checkouts to examine which products, if any, are removed from baskets or replaced before checkout.

As in some embodiments, the proof of purchase services 313 is neither a database nor a tool, the data that it processes cannot be accessed or viewed by any party, it is only the generated analytics that are available to partners. Only analytics that relate to data inputted by a party are viewable by that party. For security purposes, and the protection of user information, the proof of purchase services 313 will use hashes to identify the user IDs and passwords. Access to the service and the control panel 404 may be provided to other parties on prior agreement. Any party with access to the control panel 404 (e.g., a third party) can only use the data on a prior agreement.

Hidden SKUs

The system 100 provides the ability to manage hidden SKUs. This enables retailers to create hidden (not publicly accessible) product records/SKUs within their retail system 502 which can include a price reduction or other special offer. These hidden SKUs are made available to the system 100 via the product catalog and availability synchronization services 313. The hidden SKUs are not available publicly via a retail system 502 (via API or listed on a retailer website 502 for example). The retailer allows the system 100 to access the hidden SKUs via the product catalog and synchronization services 313 via an API endpoint, or by making them accessible via a URL/webpage which the system 100 can be granted access to via IP address whitelisting, but are not publicly accessible. The hidden SKUs are written to the database 102 and can then be utilized by the format chooser services 312 and price and offers services 310 and then presented to the user as product recommendations in distributed commerce tools 106 and included in the price and offers feed 603 on merchant systems 105.

Loyalty and Rewards Services

In some embodiments, the distributed commerce system 100 provides loyalty and rewards services 316 wherein consumers are offered coupons which reward the purchase of a related product or bundle of products via the distributed commerce tools 106, as shown in FIG. 25. These rewards are authorized after they have been purchased via online or in-store checkout 506 on a retailer system 502, as shown in FIG. 26. Purchases are analyzed on a product by product level by the system 100.

The system 100 allows users to capture coupons in a number of ways. Shoppers can send corresponding products direct to an online basket at a retailer system 502 via the system 100 and when they do so the transaction data 205 for this action is captured to records in the database 102 which relate to the master user record. Shoppers can also capture the coupons and rewards to a cloud shopping list record associated with their master user record. Qualifying purchases are then validated via the mechanism described below.

In-store transactions, illustrated in FIG. 8, result in a unique transaction reference number 202 that is provided to the user by the retailer system 502 either in the form of a printed point of sales receipt or electronically via the point of sale system. After the transaction takes place the unique transaction reference 202 is sent via a distributed commerce tool 106 to the proof of purchase (basket level conversion) services 313 which will in turn submit a query with the unique transaction reference 202 to a retailer system 502 which will return related transaction data 203. Similarly for online transactions at a retailer system 502, illustrated in FIG. 7 (but without the need for a unique transaction reference 202), these retailer systems 502 will automatically send the transaction data 203 to the proof of purchase (basket level conversion) services 313 via an API for every relevant online checkout 506. In both scenarios, the proof of purchase (basket level conversion) services 313 then uses this transaction data 203 and the transaction data 205 stored in our database 102 to establish if the user purchased a given item, the purchase of which is communicated to the loyalty and rewards services 316 to check if it qualifies the user for a reward. The system 100 then automatically adds validated rewards, loyalty points and cashback to the master user record in the database 102. The user can then redeem the balance (e.g., to the nearest $1). In the preferred embodiment, this balance is claimed as retailer credit or loyalty points, but other redemption methods are possible in other embodiments, such as via retailer gift cards, PayPal, or by other suitable means.

The loyalty and coupons manager 401 allows retailers, and suppliers to retailers, to create offers and coupons based on qualifying product purchases and then manage the distribution of monetary or other rewards to master user records in the database 102 when a qualifying purchase has been proven via the loyalty and rewards services 316 and the proof of purchase (basket level conversion) services 313.

From the foregoing, it will be appreciated that specific embodiments of the system have been described herein for purposes of illustration, but that various modifications may be made without deviating from the spirit and scope of the invention.

What is claimed is:

1. A system for integrating shoppable electronic content and electronic commerce comprising:
a distributed commerce server including a processor and one or more databases for providing management tools and distributed commerce tools; and
a merchant system in communication with the distributed commerce server over a data network, the merchant system including a retailer server maintaining one or more consumer accounts and providing the electronic commerce and at least one of a server hosting one or more web sites and a mobile application provider, each of said one or more websites and said mobile application provider providing web content,
wherein said distributed commerce tools integrates, by the processor, the shoppable electronic content, being based on said web content, with said at least one of the server hosting one or more websites and the mobile application provider, the shoppable electronic content being embedded as a hyperlink directly on the one or more websites and the mobile application making directly available the electronic commerce from said retailer server over the data network by electronic product reference codes,
the distributed commerce server publishing, by the processor, updates to the consumer accounts by mapping the shoppable electronic content to the web content, the shoppable electronic content being identified from the electronic product reference codes by the processor performing natural language processing.

2. The system of claim 1, wherein said merchant system further comprises at least one of broadcast media and print media, the at least one of the broadcast media and print media providing the electronic product reference codes associated with electronic commerce available from said retailer server.

3. The system of claim 1, wherein said database maintains a master record including at least one user record and at least one transaction record for a particular user.

4. The system of claim 3, wherein said at least one user record including a user ID, an e-mail hash, a list of associated cookies, an adID, tokens and sessions, a list of retailer accounts linked to the particular user, and a list of transactions linked to the particular user, said at least one transaction record including a Transaction ID, a User ID, a Transaction type, an Associated advertisement, an Associated recipe, an Associated bundle ID, a list of products, coupons or smartProduct IDs added to basket, quantity and size data, Transaction status, a Transaction created timestamp, a Transaction updated timestamp, and an Offer expiry timestamp.

5. The system of claim 1, wherein said distributed commerce tools include at least one of embeddable widgets, application programming interfaces, software development kits, and digital advertising, and provide the shoppable electronic content that can include at least one of basic advertisements, browsable advertisements, interactive voting advertisements, real-time special offer advertisements, and shoppable videos.

6. The system of claim 1, wherein said management tools receive on-boarded content from said merchant system, and provides content syndication throughout the merchant system.

7. The system of claim 1, wherein said distributed commerce server further provides at least one of an electronic basket for making the electronic commerce available from said retailer server and a cloud list for aggregating a list of electronic commerce available from said retailer server.

8. The system of claim 1, wherein said distributed commerce server further comprises at least one of a loyalty and rewards service for providing rewards based on transactions with said retailer server, and an account management services to maintain user accounts associated with said retailer server.

9. The system of claim 1, wherein said database of the distributed commerce server stores a master record including at least one user record and at least one transaction record and wherein the distributed commerce tools provide targeted shoppable electronic content based on the master record.

10. A method for integrating shoppable electronic content and electronic commerce comprising:
embedding distributed commerce tools at a merchant system by a processing device of a distributed commerce server;
associating user accounts from said merchant system to a database by the processing device; and
providing the shoppable electronic content via said distributed commerce tools to at least one of a server hosting one or more websites and a mobile application provider, and
publishing, by the processor, updates to one or more consumer accounts by mapping the shoppable electronic content to web content, the shoppable electronic content being identified from electronic product reference codes by the processor performing natural language processing,
wherein said merchant system includes a retailer server maintaining the one or more consumer accounts and providing the electronic commerce and at least one of a server hosting one or more websites and a mobile application provider, each of said one or more websites and said mobile application provider providing the web content, and said distributed commerce tools integrates the shoppable electronic content, being based on said web content, with said at least one of the server hosting one or more websites and the mobile application provider by the processor, the shoppable electronic content being embedded as a hyperlink directly on the one or more websites and the mobile application making directly available the electronic commerce from said retailer server over the data network by the electronic product reference codes.

11. The method of claim 10, wherein merchant system further comprises at least one of broadcast media and print media, the at least one of broadcast media and print media providing reference codes associated with electronic commerce available from said retailer server.

12. The method of claim 10, wherein said associating user accounts from said merchant system to a database via a distributed commerce server includes maintaining a master record including at least one user record and at least one transaction record for a particular user.

13. The method of claim 12, wherein said at least one user record includes a user ID, an e-mail hash, a list of associated cookies, an adID, tokens and sessions, a list of retailer accounts linked to the particular user, and a list of transactions linked to the particular user, said at least one transaction record includes a Transaction ID, a User ID, a Transaction type, an Associated advertisement, an Associated recipe, an Associated bundle ID, a list of products, coupons or smartProduct IDs added to basket, quantity and size data, Transaction status, a Transaction created timestamp, a Transaction updated timestamp, and an Offer expiry timestamp.

14. The method of claim 10, wherein said distributed commerce tools include at least one of embeddable widgets, application programming interfaces, software development kits, and digital advertising, and provide the shoppable electronic content that can include at least one of basic advertisements, browsable advertisements, interactive voting advertisements, real-time special offer advertisements, and shoppable videos.

15. The method of claim 10, further comprising receiving on-boarded content from said merchant server, and providing content syndication throughout the merchant system.

16. The method of claim 10, further comprising providing at least one of an electronic basket for making the electronic commerce available from said retailer server and a cloud list for aggregating a list of electronic commerce available from said retailer server.

17. The method of claim 10, wherein said distributed commerce server further comprises at least one of a loyalty and rewards service.

18. The method of claim 17, further comprising providing rewards based on transactions with said retailer server.

19. The method of claim 18, wherein said providing rewards based on transactions with said retailer server further comprises determining a successful proof of purchase of the electronic commerce from said retailer server.

20. The method of claim 10, wherein said database of the distributed commerce server wherein stores a master record including at least one user record and at least one transaction record and wherein the distributed commerce tools provide targeted shoppable electronic content based on the master record.
